(19) United States
(12) Patent Application Publication
(10) Pub. No.: US 2023/0253635 A1
(43) Pub. Date: Aug. 10, 2023

(54) RECHARGEABLE BATTERY PACK HAVING A POUCH CELL, AND METHOD

(71) Applicant: Hilti Aktiengesellschaft, Schaan (LI)

(72) Inventors: Klaus HAUSER, Schwabmünchen (DE); Matthias LEPIORZ, Chemnitz (DE); Moses ENDER, Buchs (CH); Nora MARTINY, Herrsching-Breitbrunn (DE); Robert STANGER, Kaufbeuren (DE); Bernd ZIEGLER, Schabmünchen (DE); Kathrin SAX, Scheuring (DE)

(21) Appl. No.: 18/015,662

(22) PCT Filed: Jul. 5, 2021
(86) PCT No.: PCT/EP2021/068509

§ 371 Date: Jan. 11, 2023

(30) Foreign Application Priority Data
Jul. 16, 2020 (EP) 20186137.4

(51) Int. Cl. H01M 10/42; H01M 50/211; H01M 50/119; H01M 10/48; H01M 50/574; H01M 50/105

(52) U.S. Cl. CPC H01M 10/4264; H01M 50/211; H01M 50/119; H01M 10/482; H01M 50/574; H01M 50/105; H01M 2010/4271

(57) ABSTRACT

A rechargeable battery pack having at least two pouch cells stacked on top of one another, wherein each of the pouch cells is enclosed in a metal foil, wherein the metal foils are electrically insulated from one another and electrical contact is made with each of the metal foils for the purpose of measuring a capacitor capacitance formed by the metal foils.

The present invention relates to a rechargeable battery pack having at least two pouch cells stacked on top of one another. Rechargeable battery packs and pouch cells are known in principle from the prior art. The phenomenon of what is known as swelling, also referred to as expansion, is likewise known from the prior art. This is problematic since it can lead to an outer cover of the pouch cell bursting open. As a result, the rechargeable battery pack itself or its electronics may in turn be damaged, which may result in a risk to the user.

### BACKGROUND

The European patent application EP 3 591 739 A1 describes a rechargeable battery pack having a pouch cell, wherein the rechargeable battery pack has at least one current interrupter which is designed to at least temporarily interrupt a current draw from the pouch cell, wherein the current interrupter is triggered by expansion of the pouch cell.

The European patent application EP 3 588 607 A1 discloses a rechargeable battery pack having at least one pouch cell, wherein the rechargeable battery pack has at least one electrically conductive filament which surrounds or bounds the pouch cell at least in sections in such a way that expansion of the pouch cell causes severing of the filament.

### SUMMARY OF THE INVENTION

It is an object of the present invention to provide an alternatively configured rechargeable battery pack that provides the basis for increased operational safety.

The present invention provides that the metal foils are electrically insulated from one another and electrical contact is made with each of the metal foils for the purpose of measuring a capacitor capacitance formed by the metal foils.

The invention includes the knowledge that a metal foil enveloping the pouch cell—or at least a foil with metallic components—can be used as the electrode of a capacitor. A capacitor, a parallel circuit or a series circuit of capacitors can thus be constructed from two or more pouch cells stacked on top of one another. A capacitor capacitance formed by the capacitor or capacitors can advantageously be measured using a suitable capacitance measuring circuit. Deformation of the cells changes the distance between the electrodes and thus the capacitor capacitance. A change in the capacitance can be evaluated as a measure of the swelling of one or more pouch cells of the rechargeable battery pack. The swelling of the pouch cells can have different characteristics. It is thus conceivable for an average distance between the electrodes to increase in the course of swelling. Otherwise it is also conceivable for an average distance between the electrodes to decrease in the course of the swelling. In both cases, however, there is a change in the capacitor capacitance, which can serve as the basis for capacitive detection.

In a particularly preferred configuration, the metal foils are spaced apart from one another in the stacking direction by an air gap. It has been found to be advantageous if a dielectric is introduced into the air gap. The dielectric can be a ceramic dielectric, for example. It has been found to be advantageous if the dielectric is a plastic, in particular a temperature-resistant plastic. In a particularly preferred configuration, the plastic is selected from the group: polyethylene terephthalate (PET), polyethylene naphthalate (PEN), polyphenylene sulfide (PPS), polypropylene (PP), polytetrafluoroethylene (PTFE), polystyrene (PS), polycarbonate (PC) it has been found to be advantageous if the dielectric is sandwiched and/or flat between the at least two pouch cells stacked on top of one another. In this way, in addition to the desired dielectric properties, the pouch cells can also be stabilized or, for example, protected against impacts in the course of using the rechargeable battery pack. The dielectric can be part of a metal-plastic composite foil.

In a further preferred configuration, the metal foils are each provided as metal composite foils, in particular as aluminum composite foils. It has been found to be advantageous if the mutually facing sides of the metal foils each define an electrode. In a further preferred configuration, the electrodes are spaced apart from one another and electrically insulated from one another.

In a particularly preferred configuration, the rechargeable battery pack has a capacitance measuring circuit that is electrically connected to the metal foils. The capacitance measuring circuit can be provided in the form of an integrated circuit and/or can be part of a battery management system of a rechargeable battery pack or an electrical handheld power tool. For the latter case, the capacitance measuring circuit can be completely or partially part of the electrical handheld power tool itself. The capacitance measuring circuit can advantageously be used to measure a capacitor capacitance between the electrodes. It has been found to be advantageous if the capacitor capacitance is monitored continuously. Alternatively, the capacitor capacitance can be monitored discontinuously, for example regularly when starting to use the rechargeable battery or in certain load cases. In a particularly preferred configuration, the rechargeable battery pack and/or a battery management system of the rechargeable battery pack is/are designed to interrupt or reduce a current draw from the rechargeable battery pack when the value of the capacitor capacitance changes by a predefined threshold value.

In a further preferred configuration, the rechargeable battery pack has a filter circuit which is configured to filter out a change in the capacitor capacitance induced by impact and/or vibration. In other words, provision may be made for a change in the capacitor capacitance which is only temporary per se and is determined by the capacitance measuring circuit to not be taken into account by a possibly provided battery management system. It has been found to be advantageous if the filter is configured to filter out a merely temporary change in the capacitor capacitance induced by thermal expansion.

In a further preferred configuration, the rechargeable battery pack has a plurality of pouch cells stacked on top of one another, wherein the metal foils of two adjacent pouch cells define a respective capacitor capacitance. The capacitor capacitances formed in this way can be coupled in series or in parallel and connected to the capacitance measuring circuit. Alternatively, a capacitance measuring circuit can be provided for each pairing of respectively adjacent pouch cells.

It has been found to be advantageous if the rechargeable battery pack is designed for connection to an electrical handheld power tool. The rechargeable battery pack is advantageously part of a system having an electrical handheld power tool.

The invention also leads to a method for measuring the swelling of a pouch cell of a rechargeable battery pack of the type described above, wherein a change in the capacitor capacitance formed between the metal foils is evaluated as a measure of the swelling of the pouch cell. It has been found to be advantageous if, as part of the method, a current draw from the rechargeable battery pack is interrupted or reduced when the value of the capacitor capacitance changes by a predefined threshold value.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical and similar components are denoted by the same reference signs.

FIG. 1A shows a first preferred exemplary embodiment of a rechargeable battery pack according to the invention in a normal state of the pouch cells.

FIG. 1B shows the first preferred exemplary embodiment of the rechargeable battery pack according to the invention in an expanded or swollen state of the pouch cells.

### DETAILED DESCRIPTION

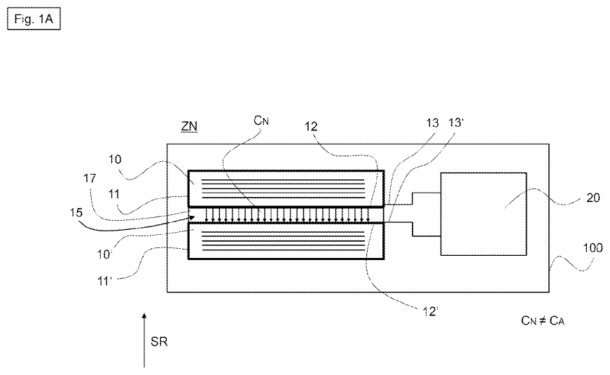

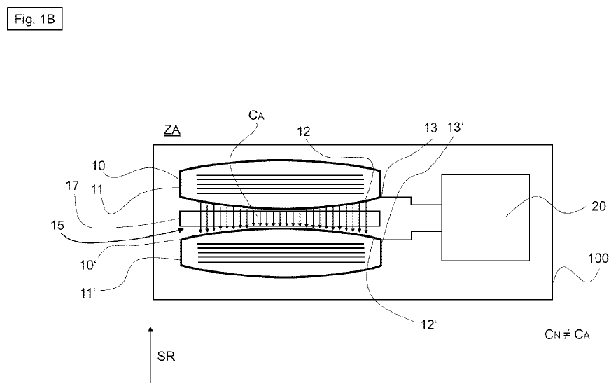

A preferred exemplary embodiment of a rechargeable battery pack 100 according to the invention is illustrated in FIG. 1.

The rechargeable battery pack is equipped, for example, with two pouch cells 10, 10′ stacked on top of one another in the stacking direction SR. Each of the pouch cells 10, 10′ is enclosed in a metal foil 11, 11′. The metal foils 11, 11′ are provided as aluminum composite foils and are electrically insulated from one another. The metal foils 11, 11′ are spaced apart from one another in the stacking direction by an air gap 15.

The mutually facing sides of the metal foils 11, 11′ each define an electrode 12, 12′, wherein an electrical capacitor capacitance exists between the electrodes 12, 12′—which are spaced apart from one another and electrically insulated from one another.

The value of the electrical capacitor capacitance depends on the distance between the electrodes 12, 12′. This shall be explained in more detail with reference to the subfigures, where FIG. 1A shows the rechargeable battery pack 100 in the normal (desired) state ZN, that is to say the pouch cells 10, 10′ are not expanded.

FIG. 1B shows the rechargeable battery pack 100 in the swollen (aged) state ZA, wherein the pouch cells 10, 10′ are visibly swollen in the stacking direction SR. In the swollen (aged) state ZA in FIG. 1B, the electrodes 12, 12′ are, for example, spaced further apart from one another (at least on average spaced further apart from one another) than the electrodes 12, 12′ in FIG. 1A. Thus the capacitor capacitance CN existing between the electrodes 12, 12′ of the rechargeable battery pack 100 in FIG. 1A is greater than the capacitor capacitance CA existing between the electrodes 12, 12′ of the rechargeable battery pack 100 in FIG. 1B.

This change in the capacitor capacitance can be used to detect swelling of the pouch cells 10, 10′. For this, electrical contact is made with each of the metal foils 11, 11′- and thus also the electrodes 12, 12′—via an electrical contact 13, 13′. The electrical contact 13, 13′ is in turn electrically connected to a capacitance measuring circuit 20 which can be used to measure the capacitor capacitance which varies as the cell ages.

As can be gathered from FIGS. 1A and 1B, an additional dielectric 17 is introduced into the air gap 15 between the pouch cells 10, 10′.

It should be mentioned that, for the measuring principle proposed here, the air present between the pouch cells 10, 10′ can in itself already be sufficient as a dielectric. Due to the introduced dielectric 17—here, for example, in the form of a plastic strip—the capacitor capacitance is in principle advantageously increased and the pouch cells 10, 10′ are simultaneously supported against one another.

### LIST OF REFERENCE SIGNS

10, 10′ Pouch cell
11, 11′ Metal foil
12, 12′ Electrode
13, 13′ Electrical contact
15 Air gap
17 Dielectric
20 Capacitance measuring circuit
100 Rechargeable battery pack
SR Stacking direction
CA Capacitor capacitance for an expanded pouch cell
CN Capacitor capacitance for a normal pouch cell
ZA Swollen state
ZN Normal state

1-11. (canceled)

12: A rechargeable battery pack comprising:
at least two pouch cells stacked on top of one another, each of the pouch cells being enclosed in a metal foil;
the metal foils being electrically insulated from one another and electrical contact being made with each of the metal foils for the purpose of measuring a capacitor capacitance formed by the metal foils.

13: The rechargeable battery pack as recited in claim 12 further comprising a capacitance measuring circuit electrically connected to the metal foils.

14: The rechargeable battery pack as recited in claim 13 further comprising a battery management system designed to interrupt or reduce a current draw from the rechargeable battery pack when a value of the capacitor capacitance changes by a predefined threshold value.

15: The rechargeable battery pack as recited in claim 14 further comprising a filter circuit configured to filter out a change in the capacitor capacitance induced by impact or vibration.

16: The rechargeable battery pack as recited in claim 13 further comprising a filter circuit configured to filter out a change in the capacitor capacitance induced by impact or vibration.

17: The rechargeable battery pack as recited in claim 12 wherein the metal foils are spaced apart from one another in the stacking direction by an air gap.

18: The rechargeable battery pack as recited in claim 17 further comprising a dielectric introduced in the air gap.

19. The rechargeable battery pack as recited in claim 18 wherein the dielectric is a plastic.

20: The rechargeable battery pack as recited in claim 12 wherein the metal foils are each a metal composite foil.

21: The rechargeable battery pack as recited in claim 20 wherein the metal foils are each an aluminum composite foil.

22: The rechargeable battery pack as recited in claim 20 wherein the dielectric is part of at least one of the metal composite foils.

23: A method for measuring the swelling of a pouch cell of a rechargeable battery pack as recited in claim 12, the method comprising evaluating a change in the capacitor capacitance formed between the metal foils as a measure of the swelling of the pouch cell.

24: The method as recited in claim 23 further comprising interrupting or reducing a current draw from the rechargeable battery pack when the value of the capacitor capacitance changes by a predefined threshold value.
